(19) United States
(12) Patent Application Publication
(10) Pub. No.: US 2021/0390355 A1
(43) Pub. Date: Dec. 16, 2021

(54) IMAGE CLASSIFICATION METHOD BASED ON RELIABLE WEIGHTED OPTIMAL TRANSPORT (RWOT)

(71) Applicant: Zhejiang University, Hangzhou (CN)

(72) Inventors: Renjun Xu, Hangzhou (CN); Weiming Liu, Hangzhou (CN); Jiuming Lin, Hangzhou (CN); Xinyue Qian, Hangzhou (CN); Xiaoyue Hu, Hangzhou (CN); Yin Zhao, Hangzhou (CN); Jingcheng He, Hangzhou (CN); Zihang Zhu, Hangzhou (CN); Xu He, Hangzhou (CN); Chengbo Sun, Hangzhou (CN); Xiang Zhou, Hangzhou (CN)

(21) Appl. No.: 17/347,546

(22) Filed: Jun. 14, 2021

(30) Foreign Application Priority Data
Jun. 13, 2020 (CN) 202010538943.5
Jul. 7, 2020 (CN) 202010645952.4

(51) Int. Cl. G06K 9/62; G06N 3/08; G06N 3/04

(52) U.S. Cl. CPC G06K 9/6269; G06K 9/628; G06N 3/0454; G06K 9/6298; G06N 3/08; G06K 9/6256

(57) ABSTRACT

An image classification method based on reliable weighted optimal transport (RWOT) includes: preprocessing data in a source domain, so that a deep neural network fits a sample image in the source domain to obtain a sample label; performing image labeling to add a pseudo label to a data sample in a target domain; performing node pairing to pair associated images in the source domain and the target domain; and performing automatic analysis by using a feature extractor and an adaptive discriminator, to perform image classification. The present disclosure proposes a subspace reliability method for dynamically measuring a difference between the source domain and the target domain based on spatial prototypical information and an intra-domain structure. This method can be used as a preprocessing step of an existing domain adaptation technology, and greatly improves efficiency.

### CROSS REFERENCE TO RELATED APPLICATIONS

The present application claims the benefit of Chinese Patent Application Nos. 202010538943.5 filed on Jun. 13, 2020 and 202010645952.4 filed on Jul. 7, 2020. All the above are hereby incorporated by reference in their entirety.

### TECHNICAL FIELD

The present disclosure relates to the field of image classification, and in particular, to an image classification method based on reliable weighted optimal transport (RWOT).

### BACKGROUND

As an important method in the field of computer vision, deep learning learns inherent laws and representation levels of sample data through training, and is widely used in image classification, object detection, semantic segmentation, and other fields. Traditional supervised learning needs a lot of manual data labeling, which is very time-consuming and laborious. To avoid repeated labeling, an unsupervised domain adaptation (UDA) method is intended to apply knowledge or patterns learned from a certain domain to a related domain. A source domain with rich supervision information is used to improve performance of a target domain model with no or only a few labels. Optimal transport is a desired method to realize inter-domain feature alignment. However, most existing projects based on optimal transport ignore an intra-domain structure and only realize rough pairwise matching. As a result, it is easy to misclassify a target sample distributed at an edge of a cluster or far away from a corresponding class center.

For UDA, training based on a domain-invariant feature is traditionally performed for domain transfer. Related domain-invariant feature measurement methods are as follows:

a) Maximum mean discrepancy (MMD)

As a most widely used loss function, the MMD is mainly used to measure a distance between two different but related distributions. The distance between two distributions is defined as follows:

$$M M D ( X , Y ) = {‖ \frac{1}{n} {\sum }_{i = 1}^{n} ϕ ( {x}_{i} ) - \frac{1}{m} {\sum }_{j = 1}^{m} ϕ ( {y}_{j} ) ‖}_{H}^{2}$$

H indicates that the distance is measured by mapping data to reproducing kernel Hilbert space (RKHS) by ϕ( ).

b) Correlation alignment (CORAL)

In the CORAL method, the source domain and the target domain are linearly transformed to align their respective second-order statistics (align mean values and covariance matrices).

$${l}_{C O R A L} = \frac{{‖ {C}_{S} - {C}_{T} ‖}_{F}^{2}}{4 {d}^{2}}$$

D_{S}^{ij}(D_{T}^{ij}) represents an sample in source (target) domain data under a j^{th} dimension. C_{S}(C_{T}) used to represent a covariance matrix of a feature. F represents a Frobenius norm of the matrix, and d represents a data dimension.

c) Kullback-Leibler divergence (KL)

The KL is used to measure different degrees of two probability distributions. It is assumed that P(x), Q(x) are two probability distributions.

$$d ( P , Q ) = {D}_{K L} ( P \vert \vert Q ) = {\sum }_{i} P ( i ) log ( \frac{P ( i )}{Q ( i )} )$$

Domain transfer is performed through adversarial training.

d) Domain-adversarial neural networks (DANN)

A system structure proposed in the DANN includes a feature extractor and a label predictor that constitute a standard feedforward neural network. In a backpropagation-based training process, a gradient reversal layer multiplies a gradient by a certain negative constant to connect a domain classifier to the feature extractor to realize UDA. Gradient reversal ensures that feature distributions in two domains are similar (it is difficult for the domain classifier to distinguish between them), resulting in domain-invariant features.

e) Adversarial discriminative domain adaption (ADDA)

i. At first, a source domain encoder (a convolutional neural network) is pre-trained using labeled source domain data.

ii. Then, a target domain encoder (also a convolutional neural network) is trained, so that a classifier used to determine whether a sample comes from the source domain or the target domain cannot perform classification reliably, thereby realizing adversarial adaptation.

In a testing process, an image in the target domain is encoded by the target encoder, mapped to shared feature space, and classified by the pre-trained classifier in step i.

The prior art has the following shortcomings:

1. Latent semantic information is not mined.

In the research on the UDA technology, the optimal transport technology is usually used to obtain a joint representation of the source domain and the target domain. A difference between distributions in the two domains is the key of the UDA technology. However, when this difference is described, the existing research often ignores prototypical information and intra-domain structure information, and as a result, the latent semantic information is not mined.

2. Negative transfer

In the prior art, during optimal transport, due to a dissimilarity between the source domain and the target domain, or because the transfer learning method does not find any component that can be transferred, knowledge learned in the source domain may cause a negative effect on learning in the target domain, in other words, negative transfer.

3. A clustering feature is not significant.

Inconsistent data sources in the source domain and the target domain lead to a huge difference between different domains. One way to reduce the difference is invariant feature representation in a learning domain. In the prior art, a mined deep clustering feature is not significant, and does not have desired robustness or effects.

### SUMMARY

To overcome the shortcomings in the prior art, the present disclosure proposes a shrinking subspace reliability method for dynamically measuring a difference between sample level domains based on spatial prototypical information and an intra-domain structure, and a weighted optimal transport strategy based on shrinking subspace reliability (SSR). Spatial prototypes of different classes in a supervised source domain are learned to predict a pseudo label for each sample in the target domain, and then an organic mixture between a prototypical distance and a predictor prediction is used during training. Considering negative transfer caused by a target sample located at the edge of a cluster, more latent semantic information is mined by reducing a possibility of subspace, to be specific, by using a trusted pseudo label to measure a difference between different domains, including spatial prototypical information and intra-domain structure information. This technology can be used as a preprocessing method of domain adaption, and greatly improves efficiency. Reliable semantic information is introduced into an optimal transport technology to construct a weighted optimal transport technology, thereby ensuring stable high-dimensional matching and enhancing reliability of pairing. Based on an idea that samples of a same class should be close to each other in feature space, the present disclosure clusters similar samples according to clustering and metric learning strategies, to enhance measurability of the samples and obtain more significant clustering features.

An objective of the present disclosure is implemented using an image classification method based on RWOT. The method includes the following steps:

(1) preprocessing data in a source domain, so that a deep neural network fits a sample image in the source domain to obtain a sample label, where this step specifically includes the following substeps:

(1.1) inputting the sample image in the source domain D^{S} into the deep neural network, where the deep neural network is constituted by a feature extractor G_{f} and an adaptive discriminator G_{y};

(1.2) computing, by the feature extractor G_{f}, a sample feature corresponding to the sample image in D^{S}; and

(1.3) computing, by the adaptive discriminator G_{y}, a supervised sample label based on the sample feature;

(2) aggregating, through RWOT and reliability measurement, most matching images between the source domain D^{S} and a target domain D^{t} to realize pairing, labeling, and analysis, where this step specifically includes the following substeps:

(2.1) image labeling: adding a pseudo label to a data sample in the target domain, including:

(2.1.1) optimizing a transport cross-entropy loss of each data sample using an SSR method and the deep neural network in step (1), and establishing a manner of measuring spatial prototypical information for the source domain and the target domain, where a specific process is as follows:

a. exploiting a discriminative spatial prototype to quantify the prototypical information between the source domain and the target domain, where the prototypical information is a spatial position of information that is found for a given class k and that can represent a feature of the class; it is now determined by the distances of a target sample from each class center of the source domain in the feature space; for each class k in the source domain, a “class center” is defined and denoted as cₖ^{s}, cₖ^{s}∈R^{C×d}, the space is C×d-dimensional; C represents a total quantity of image classes in the source domain D^{S}, and d represents a dimension of a feature layer output by the feature extractor G_{f} in the deep neural network; and a matrix D recording the spatial prototype is expressed by a formula (1):

$$D ( i , k ) = \frac{{e}^{- d ( {G}_{f} ( {x}_{i}^{t} ) , {c}_{k}^{s} )}}{{{\sum }^{C}}_{m = 1} {e}^{- d ( {G}_{f} ( {x}_{i}^{t} ) , {c}_{m}^{s} )}} \qquad ( 1 )$$

where xᵢ^{t} represents an i^{th} sample in the target domain, q, represents a prototype of a k^{th} class in the source domain, namely, a k^{th} class center in the source domain d(G_{f}(xᵢ^{t}),cₖ^{s}) represents a distance between a target sample G_{f}(xᵢ^{t}) and the k^{th} class center cₖ^{s} in the source domain, k=1, 2, 3, . . . , and C, d(G_{f}(xᵢ^{t}),cₘ^{s}) represents a distance between the target sample G_{f}(xᵢ^{t}) and an m^{th} class center cₘ^{s} in the source domain, the function d in the numerator represents a distance between a sample image transformed from a sample image in the target domain by the feature extractor G_{f} and a current sample center of the k^{th} class, and in the denominator, a distance between the sample image in the target domain and each class center of the C classes is summarized to normalize distance results of different classes;

b. reducing, by the function d used for distance measurement, a test error using a plurality of kernels based on different distance definitions, where a multi-kernel formula is as follows:

d(G_{f}*xᵢ^{t}),cₖ^{s})=K(cₖ^{s},cₖ^{s})−2K(G_{f}(xᵢ^{t}),cₖ^{s})+K(G_{f}(xᵢ^{t}),G_{f}(xᵢ^{t})) (2)

where K is in a form of a positive semidefinite (PSD) kernel, and has the following form:

$$κ = \{ K = {\sum }_{u = 1}^{m} {β}_{u} {K}_{u} \text{:} {\sum }_{u = 1}^{m} {β}_{u} = 1 , {β}_{u} \geq 0 , ∀ u \} \qquad ( 3 )$$

where Kᵤ represents each kernel in a set, K represents a total result obtained after all of the plurality of kernels work together, u is an ergodic parameter and satisfies that a total weight of all kernel functions is 1, m is a quantity of a plurality of Gaussian kernels, κ is a total set of all the kernel functions, and represents a set of a plurality of prototypical kernel functions used for measurement of a spatial distance, and a weight of each kernel Kᵤ is βᵤ;

c. for an image in the target domain, using outputs of the feature extractor G_{f} and the adaptive discriminator G_{y} as a predictor of pseudo label, where there is no known label in the target domain, so a sharpening probability representation matrix is used to represent a prediction probability of the pseudo label; to output a probability matrix, a Softmax function is used for probability-based normalization; and the sharpening probability representation matrix M is defined as follows:

$$M ( i , k ) = P ( y = k \vert Soft max ( \frac{{G}_{y} ( {G}_{f} ( {x}_{i}^{t} ) )}{τ} ) ) \qquad ( 4 )$$

where M(i,k) represents a probability that a target sample i belongs to the k^{th} class, represents a hyper-parameter that needs to be preset, and a highly accurate determining probability M(i,k) can be obtained through computation according to the formula (4); and

d. obtaining, upon the foregoing processes of a to c, all information of a loss function needed for optimizing SSR, where an SSR loss matrix Q is defined as follows:

$$Q ( i , k ) = \frac{{d}_{A ( k )} D ( i , k ) + ( 2 - {d}_{A ( k )} ) M ( i , k )}{{\sum }_{m = 1}^{C} ( {d}_{A ( m )} D ( i , m ) + ( 2 - {d}_{A ( m )} ) M ( i , m ) )} \qquad ( 5 )$$

where Q(i,k) represents the probability that the target sample i belongs to the k^{th} class, d_{A(k)}(Dₖ^{s},Dₖ^{t})=2(1−2ε(hₖ)), d_{A(k)} represents an A-distance measuring a discrepancy between any sample of the k^{th} class in the source domain and any sample with the predictor pseudo label being the k^{th} class in the target domain, ε(hₖ) represents an error rate of determining Dₖ^{s} and Dₖ^{t} by a discriminator hₖ, Dₖ^{s} represents the k^{th} class in the source domain, dₖ^{t} represents the k^{th} class in the target domain, and m represents an index indicator of a class;

(2.1.2) computing each class center for the images in the source domain based on the output of the feature extractor G_{f}; and based on the distance measurement of the given target sample to each source class center by kernel function in step a of step (2.1.1), a label k corresponding to the class center q, with the closest distance is chosen as a prototype pseudo label for the input target sample;

(2.1.3) unifying the predictor pseudo label and the prototype pseudo label using the loss matrix Q to obtain a trusted pseudo label, and by using a discriminative centroid loss function Lₚ and according to the following formula, making samples belonging to a same class in the source domain as close as possible in feature space, and samples belonging to a same class of trusted pseudo label in the target domain as close as possible in the feature space, samples predicted to belong to a same class in the source domain and in the target domain as close as possible in feature space, and distances in feature space between different class centers in the source domain not less than v;

$${ℒ}_{p} = {\sum }_{i = 1}^{n} {‖ {G}_{f} ( {x}_{i}^{s} ) - {c}_{{y}_{i}^{s}}^{s} ‖}_{2}^{2} + {\sum }_{k = 1}^{C} {\sum }_{i = 1}^{n} Q ( i , k ) {‖ {G}_{f} ( {x}_{i}^{t} ) - {c}_{k}^{s} ‖}_{2}^{2} + λ {\sum }_{{k}_{1} , {k}_{2} = 1 , {k}_{1} \neq {k}_{2}}^{C} max ( 0 , v - {‖ {c}_{{k}_{1}}^{s} - {c}_{{k}_{2}}^{s} ‖}_{2}^{2} ) , \qquad ( 6 )$$

where n represents a quantity of samples in each round of training; λ represents a hyper-parameter, and is determined based on experimental parameter adjustment; v represents a constraint margin to control a distance between prototypes of different classes, and needs to be set in advance; yᵢ^{s} represents a label value corresponding to the i^{th} sample image in the source domain; c_{y}_{ᵢ}_{^{s}}^{s} represents a prototype corresponding to the label value, and a formula for the class center is as follows:

$${c}_{k}^{s} = \frac{1}{S} {\sum }_{i = 1}^{n} {G}_{f} ( {x}_{i}^{s} ) φ ( {y}_{i}^{s} , k ) \qquad ( 7 )$$

where G_{f}(xᵢ^{s}) represents extraction of a feature of the i^{th} sample in the source domain; φ(yᵢ^{s},k) represents whether the i^{th} sample belongs to the k^{th} class; when yᵢ^{s}=k, φ(yᵢ^{s},k)=1 otherwise, φ(yᵢ^{s},k)=0; S represents the quantity of samples whose class is k in the source domain in a minibatch, S=Σᵢ₌₁ⁿφ(yᵢ^{s},k), and k=1, 2, . . . , and C;

(2.2) node pairing: pairing associated images in the source domain and the target domain, where this step includes the following substeps:

(2.2.1) obtaining an optimal probability distribution γ* using a minimized weighted distance definition matrix (Z matrix) and a Frobenius inner product of an operator γ in the Kantorovich problem, and according to the following formula:

$${γ}^{*} = arg {min}_{γ ∈ χ ( {𝒟}^{s} \cdot {𝒟}^{t} )} \int ℛ ( {x}^{t} , y ( {x}^{s} ) ) 𝒞 ( {x}^{s} , {x}^{t} ) d γ ( {x}^{s} , {x}^{t} ) \qquad ( 8 )$$

where [symbol] ( [symbol] ^{s}, [symbol] ^{t}) represents a joint probability distribution of the source domain [symbol] ^{s} and the target domain [symbol] ^{t}; [symbol] represents a weight between two paired samples; x^{t} represents a sample in the target domain; x^{s} represents a sample in the source domain; y(x^{s}) represents a sample label in the source domain; [symbol] represents a cost function matrix, for example, using Euclidean distance between the sample in the source domain and the sample in the target domain; dγ(x^{s},x^{t}) represents integration of all joint probability distributions of the source domain and the target domain, and because the samples are discrete and countable, a discrete form of the above formula is as follows:

$${γ}^{*} = arg {min}_{γ ∈ χ ( {𝒟}^{s} \cdot {𝒟}^{t} )} < γ , Z {>}_{F} = arg {min}_{γ ∈ χ ( {𝒟}^{s} \cdot {𝒟}^{t} )} < γ , ℛ \cdot 𝒞 {>}_{F} \qquad ( 9 )$$

(2.2.2) imposing a certain constraint on optimal transport because a higher dimension leads to poorer robustness of a result of optimal transport; evaluating, by using the loss matrix Q, a label of a current sample in the target domain; and when the source domain and the target domain are gradually aligned, considering the Euclidean distance of the paired samples in feature space and calculating a pseudo label of the sample in the target domain with a classifier trained in the source domain, so that after a weight of optimal transport is enhanced, a better and more robust pairing is achieved, a matching strategy of optimal transport is realized, and the Z matrix is optimized, where a discrete formula of the Z matrix is defined as follows:

Z(i,j)=∥G_{f}(xᵢ^{s})−G_{f}(xⱼ^{t})∥²·(1−Q(j,yᵢ^{s})) (10)

where (1−Q(j,yᵢ^{s})) represents the constraint on optimal transport, xⱼ^{t} represents a j^{th} sample in the target domain, and a source-target domain sample pair can be obtained by computing optimal transport using the Z matrix;

(2.2.3) computing a value of a distance loss L_{g} based on step (2.2.2) and according to the following formula:

$${L}_{g} = {\sum }_{i , j} {γ}_{i , j}^{*} ( {‖ {G}_{f} ( {x}_{i}^{t} ) - {G}_{f} ( {x}_{j}^{s} ) ‖}^{2} + {F}_{1} ( Soft max ( {G}_{y} ( {G}_{f} ( {x}_{i}^{t} ) ) , {y}_{j}^{s} ) ) ) \qquad ( 11 )$$

where F₁ represents a cross-entropy loss function, and Softmax is a standard normalized exponential function;

(2.3) automatic analysis: automatically analyzing a data distribution of the source domain and a data distribution of the target domain, evaluating a transfer effect, and selecting an outlier, where this step specifically includes the following substeps:

(2.3.1) importing a data sample in the source domain and a data sample in the target domain to the deep neural network in step (1) from an existing dataset;

(2.3.2) computing a spatial prototype for each class of the data sample in the source domain, and adding a prototype pseudo label to the data sample in the target domain based on the spatial prototype by using the method in step (2.1);

(2.3.3) generating, by using the feature extractor G_{f}, a corresponding feature distribution based on the data sample in the source domain and the data sample in the target domain, and obtaining a predictor pseudo label using the adaptive discriminator G_{y};

(2.3.4) unifying the prototype pseudo label and the predictor pseudo label with the loss matrix Q to obtain a trusted pseudo label; and

(2.3.5) computing, based on Euclidean distances between source-target domain sample pairs, a contribution of the source-target domain sample pair to optimal transport, sorting the contribution according to a rule that a shorter Euclidean distance leads to a larger contribution, selecting, based on a preset pairing distance threshold, source-target domain sample pairs with a distance exceeding the pairing distance threshold as outliers, and discarding the source-target sample pairs; and

(3) inputting a source-target domain sample pair retained in step (2.3.5) into the deep neural network for image classification, where this step specifically includes the following substeps:

(3.1) performing weighted-addition of the loss functions Lₚ and L₉ and a standard classification loss function L_{cls} to finally obtain a loss function that needs to be optimized, where details are as follows:

$${min}_{{G}_{y} , {G}_{f}} {L}_{cls} + α {L}_{p} + β {L}_{g} \qquad ( 12 )$$

where α, β are hyper-parameters and used to balance the loss functions Lₚ and L_{g} under different datasets to ensure training stability of the deep neural network;

the standard classification loss function is as follows:

$${L}_{cls} = \frac{1}{n} {\sum }_{i = 1}^{n} {F}_{1} ( {G}_{y} ( {G}_{f} ( {x}_{i}^{s} ) ) , {y}_{i}^{s} ) \qquad ( 13 )$$

(3.2) computing loss function values of two corresponding samples under network parameters of a model, and updating the network parameters backward successively based on a computed local gradient by backpropagation, to optimize the network; and

(3.3) when a value of a total loss function is reduced to an acceptable threshold specified based on desired accuracy, stopping training, outputting the sample label of the sample image based on G_{f} and G_{y} that are obtained through training in the deep neural network, and performing image classification based on the sample label.

Further, the feature extractor G_{f} computes corresponding sample features of the source domain and the target domain through convolution and feedforward of a deep feature network.

Further, in step (2.1.1), the manner of measuring the spatial prototypical information is a distance measurement under Euclidean space.

Further, in step (2.1.1), the discriminator hₖ is a linear Support Vector Machine (SVM) classifier.

The present disclosure has the following beneficial effects:

(1) The present disclosure proposes a subspace reliability method for dynamically measuring a difference between an unlabeled target sample and a labeled source domain based on spatial prototypical information and an intra-domain structure. This method can be used as a preprocessing step of an existing domain adaptation technology, and greatly improves efficiency.

(2) The present disclosure designs an SSR-based weighted optimal transport strategy, realizes an accurate pairwise optimal transport process, and reduces negative transfer caused by samples near a decision-making boundary of the target domain. The present disclosure provides a discriminative centroid utilization strategy to learn deep discriminative features.

(3) The present disclosure combines the SSR strategy and the optimal transport strategy, and this can realize more significant deep features and enhance robustness and effectiveness of the model. The experimental result shows that the deep neural network in the present disclosure works stably on various datasets and has better performance than multiple existing methods.

### BRIEF DESCRIPTION OF THE DRAWINGS

FIG. 1 is a schematic structural diagram of domain adaptation by a backpropagation network, where the method in the present disclosure uses a gradient backpropagation strategy (GRL) to align source and target domains;

FIG. 2 is a schematic diagram of an adversarial discriminative domain adaptation architecture, where the method in the present disclosure uses a multi-stage strategy to stably align source and target domains;

FIG. 3 is a schematic flowchart of easy transfer learning, where the method in the present disclosure evaluates, by computing the distance between a target sample i and the k^{th} class center in the source domain, and the probability that the sample i in the target domain belongs to the k^{th} class;

FIG. 4 is a schematic structural diagram of a neural network according to the present disclosure; and

FIG. 5 is a schematic flowchart of a method according to the present disclosure.

### DETAILED DESCRIPTION

Specific implementations of the present disclosure are described in further detail below with reference to the accompanying drawings.

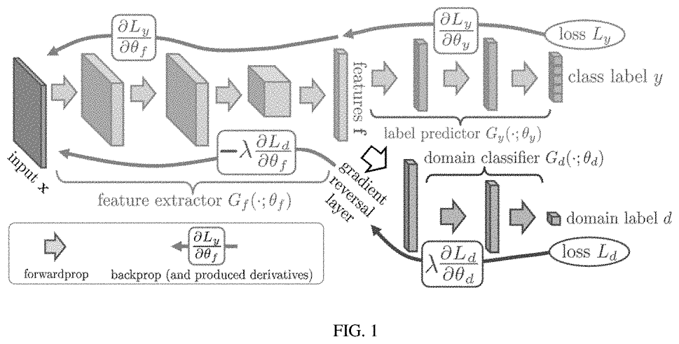

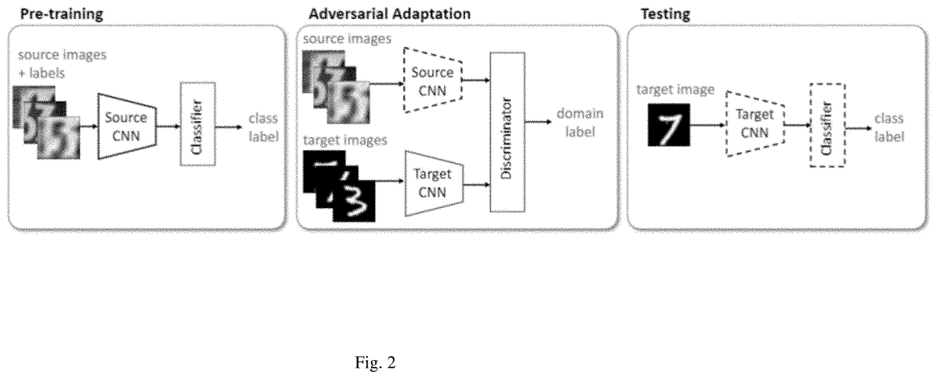

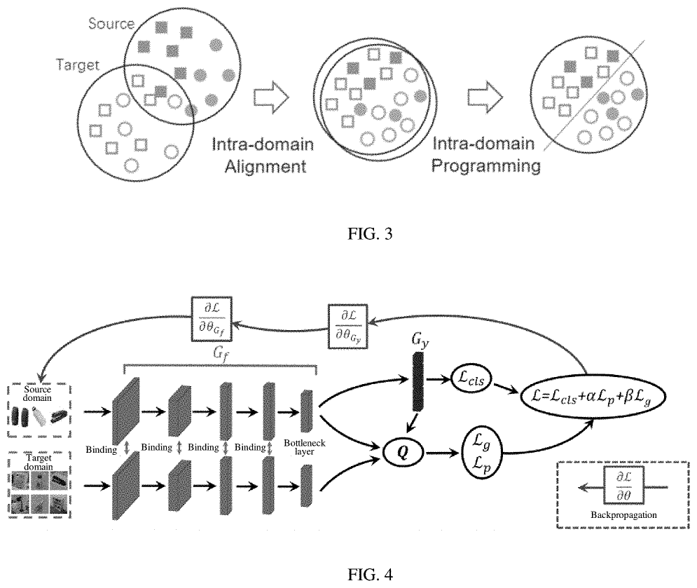

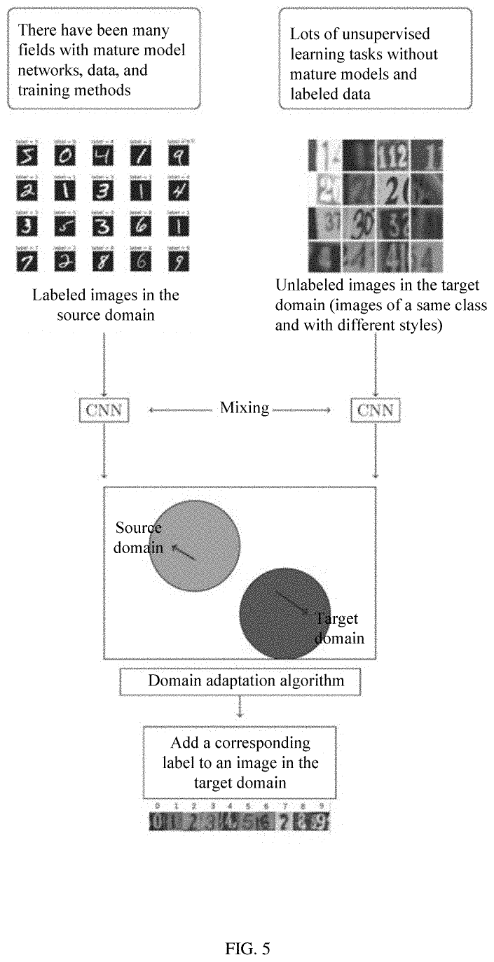

As shown in FIG. 1 to FIG. 5, an image classification method based on RWOT in the present disclosure includes the following steps.

(1) Preprocess data in the source domain, so that a deep neural network fits a sample image in the source domain to obtain a sample label. This step specifically includes the following substeps:

(1.1) Input the sample image in the source domain D^{S} into the deep neural network, where the deep neural network is constituted by a feature extractor G_{f} and an adaptive discriminator G_{y}.

(1.2) Compute, by the feature extractor G_{f} through convolution and feedforward of a deep feature network, a sample feature corresponding to the sample image in D^{S}.

(1.3) Compute, by the adaptive discriminator G_{y}, a supervised sample label based on the sample feature.

(2) Aggregate, through RWOT and reliability measurement, most matching images in the source domain D^{S} and the target domain D^{t} to realize pairing, labeling, and analysis. This step specifically includes the following substeps:

(2.1) Image labeling: Add a pseudo label to each data sample in the target domain. This step includes the following substeps:

(2.1.1) Optimize the transport cross-entropy loss of each data sample by using the SSR method and the deep neural network in step (1), and establish a manner of measuring spatial prototypical information of the source domain and the target domain (distance measurement under Euclidean space). A specific process is as follows:

a. Exploit a discriminative spatial prototype to quantify the prototypical information between the source domain and the target domain. The prototypical information is a spatial position of information that is found for a given class k and can represent a feature of the class; it is now determined by the distances of a target sample from each class center of the source domain in the feature space. For each class k in the source domain, a “class center” is defined and denoted as cₖ^{s}, cₖ^{s}∈R^{C×d}, the space is C×d-dimensional real number domain space, C represents the total quantity of image classes in the source domain, and d represents the dimension of a feature layer output by the feature extractor G_{f} in f the deep neural network. A matrix D recording the spatial prototype is expressed by the following formula:

$$D ( i , k ) = \frac{{e}^{- d ( {G}_{f} ( {x}_{i}^{t} ) , {c}_{k}^{s} )}}{{\sum }_{m = 1}^{C} {e}^{- d ( {G}_{f} ( {x}_{i}^{t} ) , {c}_{m}^{s} )}} \qquad ( 1 )$$

In the foregoing formula, xᵢ^{t} represents the i^{th} sample in the target domain, cₖ^{s} represents the prototype of the k^{th} class in the source domain, namely, the k^{th} class center in the source domain, d(G_{f}(xᵢ^{t}),cₖ^{s}) represents the distance between a target sample G_{f}(xᵢ^{t}) and the k^{th} class center cₖ^{s} in the source domain, k=1, 2, 3, . . . , and C, d(G_{f}(xᵢ^{t}),cₘ^{s}) represents the distance between the target sample G_{f}(xᵢ^{t}) and the m^{th} class center cₘ^{s} in the source domain, the function d in the numerator represents a distance between a sample image transformed from a sample image in the target domain by the feature extractor G_{f} and the current sample center of the k^{th} class, and in the denominator, the distance between the sample image in the target domain and each class center of the C classes is summarized to normalize distance results of different classes, so that the training process is more stable.

b. Reduce, by the function d used for distance measurement, a test error using a plurality of kernels based on different distance definitions, so that a method for representing an optimal prototypical distance is realized. Therefore, a multi-kernel formula is as follows:

d(G_{f}(xᵢ^{t}),cₖ^{s})=K(cₖ^{s},cₖ^{s})−2K(G_{f}(xᵢ^{t}),cₖ^{s})+K(G_{f}(xᵢ^{t}),G_{f}(xᵢ^{t})) (2)

In the foregoing formula, K is in a form of a positive semidefinite (PSD) kernel, and has the following form:

$$κ = \{ K = {\sum }_{u = 1}^{m} {β}_{u} {K}_{u} \text{:} {\sum }_{u = 1}^{m} {β}_{u} = 1 , {β}_{u} \geq 0 , ∀ u \} \qquad ( 3 )$$

In the foregoing formula, Kᵤ represents each kernel in a set, and K represents a total result obtained after all of the plurality of kernels work together. u is an ergodic parameter and satisfies that a total weight of all kernel functions is 1. m is the quantity of a plurality of Gaussian kernels, κ is a total set of all the kernel functions, and represents a set of a plurality of prototypical kernel functions used for measurement of a spatial distance, and the weight of each kernel Kᵤ is βᵤ. A range of the parameter {βᵤ} is limited to ensure that the computed multi-kernel K has features.

c. For an image in the target domain, use outputs of the feature extractor G_{f} and the adaptive discriminator G_{y} as a predictor of pseudo label. There is no known label in the target domain, so a sharpening probability representation matrix is used to represent a prediction probability of the pseudo label. To output a probability matrix, a Softmax function is used for probability-based normalization. The sharpening probability representation matrix M is defined as follows:

$$M ( i , k ) = P ( y = k \vert Soft max ( \frac{{G}_{y} ( {G}_{f} ( {x}_{i}^{t} ) )}{τ} ) ) \qquad ( 4 )$$

In the foregoing formula, M(i,k) represents a probability that a target sample i belongs to the k^{th} class, τ represents a hyper-parameter that needs to be preset, and a highly accurate determining probability M(i,k) can be obtained through computation according to the formula (4).

d. Obtain, upon the foregoing processes of a to c, all information of a loss function needed for optimizing SSR, where an SSR loss matrix Q is defined as follows:

$$Q ( i , k ) = \frac{{d}_{A ( k )} D ( i , k ) + ( 2 - {d}_{A ( k )} ) M ( i , k )}{{\sum }_{m = 1}^{C} ( {d}_{A ( m )} D ( i , m ) + ( 2 - {d}_{A ( m )} ) M ( i , m ) )} \qquad ( 5 )$$

In the foregoing formula, Q(i,k) represents the probability that the target sample i belongs to the k^{th} class, d_{A(k)}(Dₖ^{s},Dₖ^{t})=2(1−2ε(hₖ)), and d_{A(k)} represents an A-distance measuring the discrepancy between any sample of the k^{th} class in the source domain and any sample with the predictor pseudo label being the k^{th} class in the target domain. ε(hₖ) represents an error rate of determining Dₖ^{s} and dₖ^{t} by a discriminator hₖ, and the discriminator hₖ is a linear SVM classifier. Dₖ^{s} represents the k^{th} class in the source domain, Dₖ^{t} represents the k^{th} class in the target domain, and m represents an index indicator of a class.

(2.1.2) Compute a class center for the images in the source domain and the target domain based on the output of the feature extractor G_{f}; and based on the distance measurement of the given target sample to each source class center by kernel function in step a of step (2.1.1), a label k corresponding to the class center cₖ^{s} with the closest distance is chosen as a prototype pseudo label for the input target sample;

(2.1.3) Unify the predictor pseudo label and the prototype pseudo label with the loss matrix Q, to obtain a trusted pseudo label, and by using a discriminative centroid loss function Lₚ and according to the following formula, make samples belonging to the same class in the source domain as closer as possible in the feature space, and samples belonging to the same class of trusted pseudo label in the target domain as close as possible in the feature space, samples predicted to belong to the same class in the source domain and in the target domain as close as possible in the feature space, and distances in the feature space between different class centers in the source domain not less than v. Details are as follows:

$${ℒ}_{p} = {\sum }_{i = 1}^{n} {‖ {G}_{f} ( {x}_{i}^{s} ) - {c}_{{y}_{i}^{s}}^{s} ‖}_{2}^{2} + {\sum }_{k = 1}^{C} {\sum }_{i = 1}^{n} Q ( i , k ) {‖ {G}_{f} ( {x}_{i}^{t} ) - {c}_{k}^{s} ‖}_{2}^{2} + λ {\sum }_{{k}_{1} , {k}_{2} = 1 , {k}_{1} \neq {k}_{2}}^{C} max ( 0 , v - {‖ {c}_{{k}_{1}}^{s} - {c}_{{k}_{2}}^{s} ‖}_{2}^{2} ) , \qquad ( 6 )$$

In the foregoing formula, n represents the quantity of samples in each round of training. λ represents a hyper-parameter, and is determined based on experimental parameter adjustment, and v represents a constraint margin, used to control the distance between prototypes of different classes, and needs to be set in advance. yᵢ^{s} represents the label value corresponding to the i^{th} sample image in the source domain; c_{y}_{ᵢ}_{^{s}}^{s} represents a prototype corresponding to the label value, and a formula for the class center is as follows:

$${c}_{k}^{s} = \frac{1}{S} {\sum }_{i = 1}^{n} {G}_{f} ( {x}_{i}^{s} ) φ ( {y}_{i}^{s} , k ) \qquad ( 7 )$$

In the foregoing formula, G_{f}(xᵢ^{s}) represents extraction of a feature of the i^{th} sample in the source domain; φ(yᵢ^{s},k) represents whether the i^{th} sample belongs to the k^{th} class; when yᵢ^{s}=k, φ(yᵢ^{s},k)=1, otherwise, φ(yᵢ^{s},k)=0; S represents the quantity of samples whose class is k in the source domain in a minibatch, S=Σᵢ₌₁ⁿφ(yᵢ^{s},k), and k=1, 2, . . . , and C.

(2.2) Node pairing: Pair associated images in the source domain and the target domain. This step includes the following substeps:

(2.2.1) Obtain an optimal probability distribution γ* by using a minimized weighted distance definition matrix (namely, Z matrix) and a Frobenius inner product of an operator γ in a Kantorovich problem, and according to the following formula:

$${γ}^{*} = arg {min}_{γ ∈ χ ( {𝒟}^{s} \cdot {𝒟}^{t} )} \int ℛ ( {x}^{t} , y ( {x}^{s} ) ) 𝒞 ( {x}^{s} , {x}^{t} ) d γ ( {x}^{s} , {x}^{t} ) \qquad ( 8 )$$

In the foregoing formula, [symbol] ( [symbol] ^{s}, [symbol] ^{t}) represents a joint probability distribution of the source domain [symbol] ^{s} and the target domain [symbol] ^{t}. [symbol] represents a weight between two paired samples, x^{t} represents a sample in the target domain. x^{s} represents a sample in the source domain. y(x^{s}) represents a sample label in the source domain. [symbol] represents a cost function matrix, for example, using Euclidean distance between the sample in the source domain and the sample in the target domain; and dγ(x^{s},x^{t}) represents integration of all joint probability distributions of the source domain and the target domain. Under current measurement, an optimal matching result is obtained, in other words, a source-target domain sample pair most conforming to the optimal matching result is found. Because the samples are discrete and countable, a discrete form of the above formula is as follows:

$${γ}^{*} = arg {min}_{γ ∈ χ ( {𝒟}^{s} \cdot {𝒟}^{t} )} < γ , Z {>}_{F} = arg {min}_{y ∈ χ ( {𝒟}^{s} \cdot {𝒟}^{t} )} < γ , ℛ \cdot 𝒞 {>}_{F} \qquad ( 9 )$$

(2.2.2) Impose a certain constraint on optimal transport because a higher dimension leads to poorer robustness of the result of optimal transport. In this case, the loss matrix Q is used to evaluate a label of a current sample in the target domain. When the source domain and the target domain are gradually aligned, considering the Euclidean distance of the paired samples in the feature space and calculating a pseudo label of the sample in the target domain using a classifier trained in the source domain, so that after the weight of optimal transport is enhanced, a better and more robust pairing is achieved, a matching strategy of optimal transport is realized, and the Z matrix is optimized. A discrete formula of the Z matrix is defined as follows:

Z(i,j)=∥G_{f}(xᵢ^{s})−G_{f}(xⱼ^{t})∥²·(1−Q(j,yᵢ^{s})) (10)

In the foregoing formula, (1−Q(j,yᵢ^{s})) represents the constraint on optimal transport, xⱼ^{t} represents the j^{th} sample in the target domain, and a source-target domain sample pair can be obtained by computing optimal transport by using the Z matrix.

(2.2.3) Compute a value of a distance loss L_{g} based on step (2.2.2) and according to the following formula:

$${L}_{g} = {\sum }_{i , j} {γ}_{i , j}^{*} ( {‖ {G}_{f} ( {x}_{i}^{t} ) - {G}_{f} ( {x}_{j}^{s} ) ‖}^{2} + {F}_{1} ( Soft max ( {G}_{y} ( {G}_{f} ( {x}_{i}^{t} ) ) , {y}_{j}^{s} ) ) ) \qquad ( 11 )$$

In the foregoing formula, F₁ represents a cross-entropy loss function, and Softmax is a standard exponential function.

(2.3) Automatic analysis

Automatically analyze a data distribution of the source domain and a data distribution of the target domain, evaluate a transfer effect, and select an outlier. This step specifically includes the following substeps:

(2.3.1) Import a data sample in the source domain and a data sample in the target domain to the deep neural network in step (1) from an existing dataset.

(2.3.2) Compute a spatial prototype for each class of the data sample in the source domain, and add a prototype pseudo label to the data sample in the target domain based on the spatial prototype with the method in step (2.1).

(2.3.3) Generate, by using the feature extractor G_{f}, a corresponding feature distribution based on the data sample in the source domain and the data sample in the target domain, and obtain a predictor pseudo label using the adaptive discriminator G_{y}.

(2.3.4) Unify the prototype pseudo label and the predictor pseudo label with the loss matrix Q to obtain a trusted pseudo label.

(2.3.5) Compute, based on Euclidean distances between source-target domain sample pairs, a contribution of the source-target domain sample pair to optimal transport, sort the contribution according to a rule that a shorter Euclidean distance leads to a larger contribution, select, based on a preset pairing distance threshold, source-target domain sample pairs with a distance exceeding the pairing distance threshold as outliers, and discard the source-target sample pairs.

(3) Input a source-target domain sample pair retained in step (2.3.5) into the deep neural network for image classification. This step specifically includes the following substeps:

(3.1) Perform weighted-addition on the loss functions Lₚ and L₉ and a standard classification loss function L_{cls} to finally obtain a loss function that needs to be optimized. Details are as follows:

$${min}_{{G}_{y} , {G}_{f}} {L}_{cls} + α {L}_{p} + β {L}_{g} \qquad ( 12 )$$

In the foregoing formula, α, β are hyper-parameters used to balance the loss functions Lₚ and L_{g} under different datasets to ensure training stability of the deep neural network.

The standard classification loss function is as follows:

$${L}_{cls} = \frac{1}{n} {\sum }_{i = 1}^{n} {F}_{1} ( {G}_{y} ( {G}_{f} ( {x}_{i}^{s} ) ) , {y}_{i}^{s} ) \qquad ( 13 )$$

(3.2) Compute loss function values of two corresponding samples under network parameters of a model, and update the network parameters backward successively based on a computed local gradient using backpropagation, to optimize the network.

(3.3) When the value of a total loss function is reduced to an acceptable threshold specified based on desired accuracy, stop training, output the sample label of the sample image based on G_{f} and G_{y} that are obtained through training in the deep neural network, and perform image classification based on the sample label.

As shown in FIG. 4, G_{f} represents a feature extractor, G_{y} represents an adaptive discriminator, L_{g} represents an SSR-based weighted optimal transport loss function, Lₚ represents a discriminative centroid loss function, L_{cls} represents a standard cross entropy loss function, α and β are hyper-parameters, and an SSR loss matrix Q is intended to dynamically balance contributions of spatial prototypical information and an intra-domain structure during training.

A data sample in the source domain is input from a source position, and a corresponding sample feature is computed by the feature extractor G_{f} through convolution and feedforward of a deep feature network. A supervised sample label and a classification loss L_{cls} are computed by the adaptive discriminator G_{y}. A data sample, in the target domain, corresponding to a pseudo label is obtained based on the data sample in the source domain and is input from a target position. The data sample in the target domain is processed by a feature extractor that has the same sample structure and parameter as G_{f}, and then is used together with the corresponding source sample input to obtain a feature tensor, to compute the SSR loss matrix Q. An optimal transport loss L_{g} and a discriminative centroid loss Lₚ are computed based on information of the SSR loss matrix Q. Weighted-addition is performed on the two losses and the obtained classification loss L_{cls} of the data sample in the source domain, to finally obtain a loss function that needs to be optimized. Loss function values of the two corresponding samples under current network parameters are computed, and the network parameters are updated backward successively based on a computed local gradient by using a most basic backpropagation technology in the deep neural network to optimize the network. After enough samples in the source domain and corresponding samples in the target domain are input, and a value of a total loss function decreases to an acceptable threshold, if verification accuracy of data not in a training set is improved to an acceptable value, the training can be stopped, and models G_{f} and G_{y} obtained through training are put into practical use.

The method in the present disclosure has been tested in many fields, including a digital recognition transfer learning dataset (MNIST, USPS, and SVHN datasets), an Office-31 dataset (including Amazon, Webcam, and DSLR), an ImageNet-Caltech dataset constructed based on ImageNet-1000 and Caltech-256, an Office-Home dataset, and a VisDA-2017 dataset.

For network construction, the method embodiment in the present disclosure uses PyTorch as a network model construction tool, uses ResNet-50 as a feature extraction network G_{f} for Office-31 and VISDA datasets, and carries out pre-training on Imagenet. For a digital recognition task, the method in the present disclosure uses LeNet as the feature extraction network G_{f}. In construction of a deep neural network model in the present disclosure, the embodiment uses the Gaussian kernel function, and performs hyper-parameter setting with a step of 2^{1/2} on the hyper-parameter a of the standard deviation in a range of 2⁻⁸ to 2⁸.

In neural network training, the embodiment uses a batch Stochastic Gradient Descent (SGD) optimizer, where momentum is initialized to 0.9, a batch size is initialized to 128, a hyper-parameter λ is initialized to 0.001, v is initialized to 50, another hyper-parameter constant τ representing temperature is initialized to 0.5, and a hyper-parameter m in class center computation is set to 4. In the experiment of the embodiment, α∈[10⁻³, 1] and β∈[10⁻², 1] are feasible. In the sample, α=0.01 and β=0.1 are applied to all tasks. In addition, it is found that, within the above range, an effect of the model first increases and then decreases with an increase of the two parameters.

Data is randomly input into the model based on the batch size. The model performs forward computation and backpropagation based on the data and existing parameters, and performs computation for a plurality of cycles to optimize the network parameters until the accuracy is stable.

Through the above settings and enough long-time training (until the accuracy of the model does not change significantly), results show that the average accuracy of the method is 90.8% for the office-31 dataset, 95.3% for the ImageNet-Caltech dataset, 84.0% for the VisDA-2017 dataset, and 98.3% for the digital recognition transfer task. Compared with other methods in the field, these results achieve a higher transfer recognition effect.

The above embodiment is used to explain the present disclosure, rather than to limit the present disclosure. Within the spirit of the present disclosure and the protection scope of the claims, any modification and change to the present disclosure should fall into the protection scope of the present disclosure.

What is claimed is:

1. An image classification method based on reliable weighted optimal transport (RWOT), wherein the method comprises the following steps:
(1) preprocessing data in a source domain, so that a deep neural network fits a sample image in the source domain to obtain a sample label, wherein this step specifically comprises the following substeps:
(1.1) inputting the sample image in a source domain D^{S} into the deep neural network, wherein the deep neural network is constituted by a feature extractor G_{f} and an adaptive discriminator G_{y};
(1.2) computing, by the feature extractor G_{f}, a sample feature corresponding to the sample image in D^{S}; and
(1.3) computing, by the adaptive discriminator G_{y}, a supervised sample label based on the sample feature;
(2) aggregating, through RWOT and reliability measurement, most matching images between the source domain D^{S} and a target domain D^{t} to realize pairing, labeling, and analysis, wherein this step specifically comprises the following substeps:
(2.1) image labeling: adding a pseudo label to a data sample in the target domain, comprising:
(2.1.1) optimizing a transport cross-entropy loss of each data sample by using a shrinking subspace reliability (SSR) method and the deep neural network in step (1), and establishing a manner of measuring spatial prototypical information for the source domain and the target domain, wherein a specific process is as follows:
a. exploiting a discriminative spatial prototype to quantify the prototypical information between the source domain and the target domain, wherein the prototypical information is a spatial position of information that is found for a given class k and that can represent a feature of the class; it is now determined by the distances of a target sample from each class center of the source domain in the feature space; for each class k in the source domain, a “class center” is defined and denoted as cₖ^{s}, cₖ^{s}∈R^{C×d}, the space is C×d-dimensional; C represents a total quantity of image classes in the source domain D^{S}, and d represents a dimension of a feature layer output by the feature extractor G_{f} in the deep neural network; and a matrix D recording the spatial prototype is expressed by a formula (1):
$$D ( i , k ) = \frac{{e}^{- d ( {G}_{f} ( {x}_{i}^{t} ) , {c}_{k}^{s} )}}{{\sum }_{m = 1}^{C} {e}^{- d ( {G}_{f} ( {x}_{i}^{t} ) , {c}_{m}^{s} )}} \qquad ( 1 )$$
wherein xᵢ^{t} represents an i^{th} sample in the target domain, q, represents a prototype of a k^{th} class in the source domain, namely, a k^{th} class center in the source domain d(G_{f}(xᵢ^{t}),cₖ^{s}) represents a distance between a target sample G_{f}(xᵢ^{t}) and the k^{th} class center cₖ^{s} in the source domain, k=1, 2, 3, . . . , and C, d(G_{f}(xᵢ^{t}),cₘs) represents a distance between the target sample G_{f}(xᵢt) and an m^{th} class center cₘ^{s} in the source domain, the function d in the numerator represents a distance between a sample image transformed from a sample image in the target domain by the feature extractor G_{f} and a current sample center of the k^{th} class, and in the denominator, a distance between the sample image in the target domain and each class center in the C classes is summarized to normalize distance results of different classes;
b. reducing, by the function d used for distance measurement, a test error by using a plurality of kernels based on different distance definitions, wherein a multi-kernel formula is as follows:
d(G_{f}(xᵢ^{t}),cₖ^{s})=K(cₖ^{s},cₖ^{s})−2K(G_{f}(xᵢ^{t}),cₖ^{s})+K(G_{f}(xᵢ^{t}),G_{f}(xᵢ^{t})) (2)
wherein K is in a form of a positive semidefinite (PSD) kernel, and has the following form:
$$κ = \{ K = {\sum }_{u = 1}^{m} {β}_{u} {K}_{u} \text{:} {\sum }_{u = 1}^{m} {β}_{u} = 1 , {β}_{u} \geq 0 , ∀ u \} \qquad ( 3 )$$
wherein Kᵤ represents each kernel in a set, K represents a total result obtained after all of the plurality of kernels work together, u is an ergodic parameter and satisfies that a total weight of all kernel functions is 1, m is a quantity of a plurality of Gaussian kernels, κ is a total set of all the kernel functions, and represents a set of a plurality of prototypical kernel functions used for measurement of a spatial distance, and a weight of each kernel Kᵤ is βᵤ;
c. for an image in the target domain, using outputs of the feature extractor G_{f} and the adaptive discriminator G_{y} as a predictor of pseudo label, wherein there is no known label in the target domain, so a sharpening probability representation matrix is used to represent a prediction probability of the pseudo label; to output a probability matrix, a Softmax function is used for probability-based normalization; and the sharpening probability representation matrix M is defined as follows:
$$M ( i , k ) = P ( y = k \vert Soft max ( \frac{{G}_{y} ( {G}_{f} ( {x}_{i}^{t} ) )}{τ} ) ) \qquad ( 4 )$$
wherein M(i,k) represents a probability that a target sample i belongs to the k^{th} class, τ represents a hyper-parameter that needs to be preset, and a highly accurate determining probability M(i,k) can be obtained through computation according to the formula (4); and
d. obtaining, upon the foregoing processes of a to c, all information of a loss function needed for optimizing SSR, wherein an SSR loss matrix Q is defined as follows:
$$Q ( i , k ) = \frac{{d}_{A ( k )} D ( i , k ) + 2 ( - {d}_{A ( k )} ) M ( i , k )}{{\sum }_{m = 1}^{C} ( {d}_{A ( m )} D ( i , m ) + ( 2 - {d}_{A ( m )} ) M ( i , m ) )} \qquad ( 5 )$$
wherein Q(i,k) represents the probability that the target sample i belongs to the k^{th} class, d_{A(k)}(Dₖ^{s},Dₖ^{t})=2(1−2ε(hₖ)), d_{A(k)} represents an A-distance measuring a discrepancy between any sample of the k^{th} class in the source domain and any sample with the predictor pseudo label being the k^{th} class in the target domain, ε(hₖ) represents an error rate of determining Dₖ^{s} and Dₖ^{t} by a discriminator hₖ, Dₖ^{s} represents the k^{th} class in the source domain, Dₖ^{t} represents the k^{th} class in the target domain, and m represents an index indicator of a class;
(2.1.2) computing a class center for the images in the source domain and the target domain based on the output of the feature extractor G_{f}; and based on the distance measurement of the given target sample to each source class center by kernel function in step a of step (2.1.1), a label k corresponding to the class center cₖ^{s} with the closest distance is chosen as a prototype pseudo label for the input target sample;
(2.1.3) unifying the predictor pseudo label and the prototype pseudo label using the loss matrix Q to obtain a trusted pseudo label, and by using a discriminative centroid loss function Lₚ and according to the following formula, making samples belonging to a same class in the source domain as close as possible in feature space, and samples belonging to a same class of trusted pseudo label in the target domain as close as possible in the feature space, samples predicted to belong to a same class in the source domain and in the target domain as close as possible in feature space, and distances in feature space between different class centers in the source domain not less than v, wherein details are as follows:
$${ℒ}_{p} = {\sum }_{i = 1}^{n} {‖ {G}_{f} ( {x}_{i}^{s} ) - {c}_{{y}_{i}^{s}}^{s} ‖}_{2}^{2} + {\sum }_{k = 1}^{C} {\sum }_{i = 1}^{n} Q ( i , k ) {‖ {G}_{f} ( {x}_{i}^{t} ) - {c}_{k}^{s} ‖}_{2}^{2} + λ {\sum }_{{k}_{1} , {k}_{2} = 1 , {k}_{1} \neq {k}_{2}}^{C} max ( 0 , v - {‖ {c}_{{k}_{1}}^{s} - {c}_{{k}_{2}}^{s} ‖}_{2}^{2} ) , \qquad ( 6 )$$
wherein n represents a quantity of samples in each round of training; λ represents a hyper-parameter, and is determined based on experimental parameter adjustment; v represents a constraint margin to control a distance between prototypes of different classes, and needs to be set in advance; yᵢ^{s} represents a label value corresponding to the i^{th} sample image in the source domain; c_{y}_{ᵢ}_{^{s}}^{s} represents a prototype corresponding to the label value, and a formula for the class center is as follows:
$${c}_{k}^{s} = \frac{1}{S} {\sum }_{i = 1}^{n} {G}_{f} ( {x}_{i}^{s} ) φ ( {y}_{i}^{s} , k ) \qquad ( 7 )$$
wherein G_{f}(xᵢ^{s}) represents extraction of a feature of the i^{th} sample in the source domain; φ(yᵢ^{s},k) represents whether the i^{th} sample belongs to the k^{th} class; when yᵢ^{s}=φ(yᵢ^{s},k)=1, otherwise, φ(yᵢ^{s},k)=0; S represents the quantity of samples whose class is k in the source domain in a minibatch, S=Σᵢ₌₁ⁿφ(yᵢ^{s},k), and k=1, 2, . . . , and C;
(2.2) node pairing: pairing associated images in the source domain and the target domain, wherein this step comprises the following substeps:
(2.2.1) obtaining an optimal probability distribution γ* by using a minimized weighted distance definition matrix (Z matrix) and a Frobenius inner product of an operator γ in a Kantorovich problem, and according to the following formula:
$${γ}^{*} = arg {min}_{γ ∈ χ ( {𝒟}^{s} \cdot {𝒟}^{t} )} \int ℛ ( {x}^{t} , y ( {x}^{s} ) ) 𝒞 ( {x}^{s} , {x}^{t} ) d γ ( {x}^{s} , {x}^{t} ) \qquad ( 8 )$$
wherein [symbol] ( [symbol] ^{s}, [symbol] ^{t}) represents a joint probability distribution of the source domain [symbol] ^{s} and the target domain [symbol] ^{t}; [symbol] represents a weight between two paired samples; x^{t} represents a sample in the target domain; x^{s} represents a sample in the source domain; y(x^{s}) represents a sample label in the source domain; [symbol] represents a cost function matrix, for example, using Euclidean distance between the sample in the source domain and the sample in the target domain; dγ(x^{s},x^{t}) represents integration of all joint probability distributions of the source domain and the target domain, and because the samples are discrete and countable, a discrete form of the above formula is as follows:
$${γ}^{*} = arg {min}_{γ ∈ χ ( {𝒟}^{s} \cdot {𝒟}^{t} )} < γ , Z {>}_{F} = arg {min}_{γ ∈ χ ( {𝒟}^{s} \cdot {𝒟}^{t} )} < γ , ℛ \cdot 𝒞 {>}_{F} \qquad ( 9 )$$
(2.2.2) imposing a certain constraint on optimal transport because a higher dimension leads to poorer robustness of a result of optimal transport; evaluating, by using the loss matrix Q, a label of a current sample in the target domain; and when the source domain and the target domain are gradually aligned, considering the Euclidean distance of the paired samples in feature space and calculating a pseudo label of the sample in the target domain with a classifier trained in the source domain, so that after a weight of optimal transport is enhanced, a better and more robust pairing is achieved, a matching strategy of optimal transport is realized, and the Z matrix is optimized, wherein a discrete formula of the Z matrix is defined as follows:
Z(i,j)=∥G_{f}(xᵢ^{s})−G_{f}(xⱼ^{t})∥²·(1−Q(j,yᵢ^{s})) (10)
wherein (1−Q(j,yᵢ^{s})) represents the constraint on optimal transport, xⱼ^{t} represents a j^{th} sample in the target domain, and a source-target domain sample pair can be obtained by computing optimal transport using the Z matrix;
(2.2.3) computing a value of a distance loss L_{g} based on step (2.2.2) and according to the following formula:
$${L}_{g} = {\sum }_{i , j} {γ}_{i , j}^{*} ( {‖ {G}_{f} ( {x}_{i}^{t} ) - {G}_{f} ( {x}_{j}^{s} ) ‖}^{2} + {F}_{1} ( Soft max ( {G}_{y} ( {G}_{f} ( {x}_{i}^{t} ) ) , {y}_{j}^{s} ) ) ) \qquad ( 11 )$$
wherein F₁ represents a cross-entropy loss function, and Softmax is a standard normalized exponential function;
(2.3) automatic analysis: automatically analyzing a data distribution of the source domain and a data distribution of the target domain, evaluating a transfer effect, and selecting an outlier, wherein this step specifically comprises the following substeps:
(2.3.1) importing a data sample in the source domain and a data sample in the target domain to the deep neural network in step (1) from an existing dataset;
(2.3.2) computing a spatial prototype for each class of the data sample in the source domain, and adding a prototype pseudo label to the data sample in the target domain based on the spatial prototype by using the method in step (2.1);
(2.3.3) generating, by using the feature extractor G_{f}, a corresponding feature distribution based on the data sample in the source domain and the data sample in the target domain, and obtaining a predictor pseudo label using the adaptive discriminator G_{y};
(2.3.4) unifying the prototype pseudo label and the predictor pseudo label with the loss matrix Q to obtain a trusted pseudo label; and
(2.3.5) computing, based on Euclidean distances between source-target domain sample pairs, a contribution of the source-target domain sample pair to optimal transport, sorting the contribution according to a rule that a shorter Euclidean distance leads to a larger contribution, selecting, based on a preset pairing distance threshold, source-target sample pairs with a distance exceeding the pairing distance threshold as outliers, and discarding the source-target sample pairs; and
(3) inputting a source-target domain sample pair retained in step (2.3.5) into the deep neural network for image classification, wherein this step specifically comprises the following substeps:
(3.1) performing weighted-addition of the loss functions Lₚ and L₉ and a standard classification loss function L_{cls} to finally obtain a loss function that needs to be optimized, wherein details are as follows:
$${min}_{{G}_{y} , {G}_{f}} {L}_{cls} + α {L}_{p} + β {L}_{g} \qquad ( 12 )$$
wherein α,β are hyper-parameters and used to balance the loss functions Lₚ and L_{g} under different datasets to ensure training stability of the deep neural network;
the standard classification loss function is as follows:
$${L}_{cls} = \frac{1}{n} {\sum }_{i = 1}^{n} {F}_{1} ( {G}_{y} ( {G}_{f} ( {x}_{i}^{s} ) ) , {y}_{i}^{s} ) \qquad ( 13 )$$
(3.2) computing loss function values of two corresponding samples under network parameters of a model, and updating the network parameters backward successively based on a computed local gradient by backpropagation, to optimize the network; and
(3.3) when a value of a total loss function is reduced to an acceptable threshold specified based on desired accuracy, stopping training, outputting the sample label of the sample image based on G_{f} and G_{y} that are obtained through training in the deep neural network, and performing image classification based on the sample label.

2. The image classification method based on RWOT according to claim 1, wherein the feature extractor G_{f} computes corresponding sample features of the source domain and the target domain through convolution and feedforward of a deep feature network.

3. The image classification method based on RWOT according to claim 1, wherein in step (2.1.1), the manner of measuring the spatial prototypical information is distance measurement under Euclidean space.

4. The image classification method based on RWOT according to claim 1, wherein in step (2.1.1), the discriminator hₖ is a linear Support Vector Machine (SVM) classifier.
